(19) United States
(12) Patent Application Publication
(10) Pub. No.: US 2010/0224573 A1
(43) Pub. Date: Sep. 9, 2010

(54) WASTE TRAP, KIT, AND METHOD OF USING THE SAME

(76) Inventor: Tony GRBAVAC, Chicago, IL (US)

Correspondence Address: LADAS & PARRY LLP, 224 SOUTH MICHIGAN AVENUE, SUITE 1600, CHICAGO, IL, 60604, US

(21) Appl. No.: 12/396,970

(22) Filed: Mar. 3, 2009

(51) Int. Cl. D06F 39/08; B01D 35/02

(52) U.S. Cl. 210/767; 55/385.1; 210/532.1

(57) ABSTRACT

A waste trap for a washing machine and for a dryer machine, the trap comprising a housing unit; a mounting bracket attached to housing unit, wherein the mounting bracket is attachable to a wash water discharge outlet of the washing machine and an air discharge outlet of the dryer machine; and a water dish attached to the housing unit such that the water dish is configured to receiving waste water from the washing machine and vented air from the dryer machine; wherein the housing unit provides an air gap between the water dish and the mounting bracket. The invention further provides for a kit for a waste trap for a washing machine and a dryer machine, and a method of using a waste trap for a washing machine and for a dryer machine.

### FIELD OF THE INVENTION

The present invention relates to a waste trap for use in collecting the lint from a washing and/or a drying event of a washing and/or drying machine.

### DESCRIPTION OF THE PRIOR ART

A wide variety of waste trap devices are currently available on the commercial market and an even larger number of these types of devices are known in the art of waste trap devices.

While prior art devices fulfill their respective, particular objectives and requirements, the aforementioned devices at least do not describe a waste trap that is self cleaning, requires minimal maintenance, and is substantially universally adaptable, among other features of the present invention. This combination of elements would specifically match the user's particular individual needs of making it possible to provide a means for collecting lint and/or waste from a washing and/or drying event of a washing and/or drying machine.

Therefore, a need exists for a new and improved waste trap having a self-cleaning mechanism, requiring minimal maintenance, and that can be used for small and large spaces, in industrial as well as commercial and personal settings. In this respect, the waste trap according to the present invention substantially departs from the conventional concepts and designs of the prior art, and in doing so provides an apparatus primarily developed for the purpose of providing a convenient means for making it possible to use a waste trap in order to collect and dispose of lint and/or waste from a drying and/or washing machine during a cycle of washing and/or drying.

### SUMMARY OF THE INVENTION

The present waste trap, kit and method of using the waste trap, according to the principles of the present invention, overcomes a number of the shortcomings of the prior art by providing a novel waste trap, kit and method for use in collecting the lint from a washing and/or drying machine. In its simplest terms, the waste trap includes a housing unit, a mounting bracket, and a water dish. The kit includes a housing unit, a mounting bracket, a water dish, and a laundry suds tub. The method includes the steps of obtaining a kit, attaching together a wash water discharge outlet of the washing machine to the mounting bracket of the trap, connecting together an air discharge outlet of the dryer to the mounting bracket of the trap, plumbing together the drain of the laundry suds tub to a sewer waste line, inserting the trap into the laundry suds tub, allowing the washing machine to expel waste water through the wash water discharge outlet into the water dish and into the laundry suds tub, letting air exhaust from the dryer machine expel through the air discharge outlet of the dryer machine to the trap and into the laundry suds tub, and collecting waste and/or lint from the air exhaust from a washer and/or dryer machine.

In view of the foregoing disadvantages inherent in the known types of waste trap devices now present in the prior art, the present invention provides an improved waste trap, which will be described subsequently in great detail, is to provide a new and improved waste trap which is not anticipated, rendered obvious, suggested, or even implied by the prior art, either alone or in any combination thereof.

To attain this, the present invention essentially comprises a housing unit, a mounting bracket, and a water dish; a kit including the same; and a method of using the waste trap.

There has thus been outlined, rather broadly, the more important features of the invention in order that the detailed description thereof that follows may be better understood, and in order that the present contribution of the art may be better appreciated.

Numerous aspects, features and advantages of the present invention will be readily apparent to those of ordinary skill in the art upon reading of the following detailed description of presently preferred, but nonetheless illustrative, embodiments of the present invention when taken in conjunction with the accompany drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an aspect of the present invention to provide a new and improved waste trap that has many of the advantages of the prior waste trap devices and minimizing a number of their disadvantages.

It is another aspect of the present invention to provide a new and improved waste trap and kit that may be easily and efficiently manufactured and marketed.

An even further aspect of the present invention is to provide a new and improved waste trap and kit that has a low cost of manufacture with regard to both materials and labor, and which accordingly is then susceptible of low prices of sale to the consuming public, thereby making the waste trap and kit economically available to the buying public.

Still another aspect of the present invention is to provide a waste trap that provides in the apparatuses and methods of the prior art some of the advantages thererof, while simultaneously overcoming some of the disadvantages normally associated therewith.

Even still another aspect of the present invention is to provide a waste trap having a housing, a mounting bracket, and a water dish.

Still another aspect of the present invention is to provide a kit comprising the un-interconnected elements of the device and further comprising a suds tub.

Lastly, it is an aspect of the present invention to provide a new and improved method of using the waste trap comprising the steps of obtaining, attaching, connecting, plumbing, inserting, allowing, letting, and collecting; with optional steps including positioning and securing; and further wherein the obtaining step may include a kit comprising a lid.

Unless otherwise defined, all scientific and technical terms used herein are to be construed as having the same meaning as commonly understood by one of ordinary skill in the art to which this invention pertains. Although methods and materials similar or equivalent to those described herein can be used in the practice or testing of the present invention, the preferred methods and materials are described below. All publications, patent applications, patents, and other references mentioned herein are incorporated by reference in their entirety. In case of conflict, the present document, including definitions, will control. Unless otherwise indicated, materials, methods, and examples described herein are illustrative only and not intended to be limiting.

There has thus been outlined, rather broadly, the more important features of the invention in order that the detailed description thereof that follows may be better understood, and in order that the present contribution of the art may be better appreciated.

Numerous other features and advantages of the present invention will be readily apparent to those of ordinary skill in the art upon reading of the following detailed description of presently preferred, but nonetheless illustrative, embodiments of the present invention when taken in conjunction with the accompany drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other aspects of the invention, along with the various features of novelty that characterize the invention, are pointed out with particularity in the claims annexed to and forming a part of this disclosure. For a better understanding of the invention, its operating advantages and the specific aspects attained by its uses, reference should be had to the accompanying drawings and description matter in which there are illustrated preferred embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; and the term “or,” is inclusive, meaning and/or. Definitions for certain words and phrases are provided throughout this patent document, those of ordinary skill in the art should understand that in many, if not most instances, such definitions apply to prior, as well as future uses of such defined words and phrases.

As used herein the specification, “a” or “an” may mean one or more. As used herein in the claim(s), when used in conjunction with the word “comprising”, the words “a” or “an” may mean one or more than one.

### BRIEF DESCRIPTION OF THE DRAWINGS

The invention will be better understood and aspects other than those set forth above will become apparent when consideration is given to the following detailed description thereof. Such description makes reference to the annexed drawings wherein:

FIG. 1 is a perspective view of an embodiment of the waste trap constructed in accordance with the principles of the present invention;

FIG. 2 is a perspective view of an embodiment of the waste trap of the present invention;

FIG. 3 is a top view of an embodiment of a mounting bracket of the present invention;

FIG. 4 is a perspective view of an embodiment of a laundry suds tub of the invention; and

FIG. 5 is a perspective view of an embodiment of an optional u-tube of the present invention.

The same reference numerals refer to the same parts throughout the various figures.

### DETAILED DESCRIPTION OF THE PREFERRED EMBODIMENT

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art.

The following detailed embodiments presented herein are for illustrative purposes. That is, these detailed embodiments are intended to be exemplary of the present invention for the purposes of providing and aiding a person skilled in the pertinent art to readily understand how to make and use of the present invention.

Accordingly, the detailed discussion herein of one or more embodiments is not intended, nor is to be construed, to limit the metes and bounds of the patent protection afforded the present invention, in which the scope of patent protection is intended to be defined by the claims and their equivalents thereof. Therefore, embodiments not specifically addressed herein, such as adaptations, variations, modifications, and equivalent arrangements, should be and are considered to be implicitly disclosed by the illustrative embodiments and claims described herein and therefore fall within the scope of the present invention.

Further, it should be understood that, although steps of the claimed method may be shown and described as being in a sequence or temporal order, the steps of any such method are not limited to being carried out in any particular sequence or order, absent an indication otherwise. That is, the claimed method steps are to be considered to be capable of being carried out in any sequential combination or permutation order while still falling within the scope of the present invention.

Additionally, it is important to note that each term used herein refers to that which a person skilled in the relevant art would understand such term to mean based on the contextual use of such term herein. To the extent that the meaning of a term used herein, as understood by the person skilled in the relevant art based on the contextual use of such term, differs in any way from any particular dictionary definition of such term, it is intended that the meaning of the term as understood by the person skilled in the relevant art should prevail.

Furthermore, a person skilled in the art of reading claimed inventions should understand that “a” and “an” each generally denotes “at least one,” but does not exclude a plurality unless the contextual use dictates otherwise. And that the term “or” denotes “at least one of the items,” but does not exclude a plurality of items of the list.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in this specification do not necessarily all refer to the same embodiment. Furthermore, the particular features, structures, or characteristics may be combined in any suitable manner in one or more embodiments.

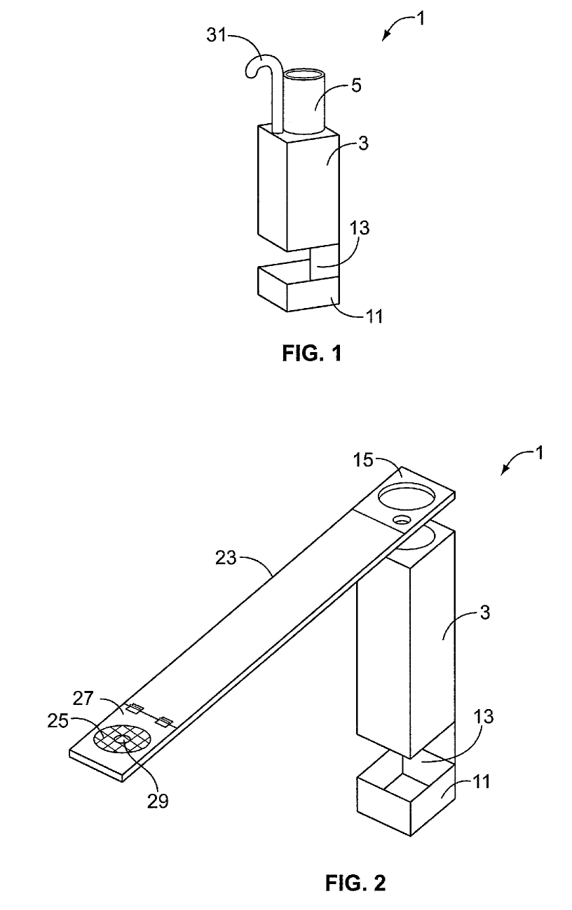

Referring now to the drawings, and in particular FIGS. 1 to 5 thereof, one preferred embodiment of the waste trap 1 is shown and generally designated by the reference numeral 1.

One preferred embodiment of the waste trap 1 is shown in FIG. 1 in a perspective view. The waste trap 1 of FIG. 1 comprises a housing unit 3 attached to a mounting bracket 5 and wherein the housing unit 3 has a water dish 11 and an air gap 13 located between the water dish 11 and the mounting bracket 5. The housing unit 3 can be made of materials such as, but not limited to, the group consisting of metal, glass, ceramic, plastic, and admixtures thereof.

If the housing unit 3 is made of metal, then metals may include, but are not limited to metals selected from the group consisting of stainless steel, vanadium, chromium, iron, nickel, cobalt, copper, zinc, molybdenum, tungsten, aluminum, and admixtures thereof. If on the other hand the housing unit 3 is made of plastic, the plastic can be selected from the group consisting of polypropylene, polyethylene, polyvinyl chloride, graphite-impregnated plastic polyester, polyurethanes, polyacryls, polymethacryls, cellulosic polymers, polystyrene, styrene-acryl copolymers, polysiloxanes, urethane-acryl copolymers, siloxane-urethane copolymers, polyurethane-polymethacryl mixtures, vinyl acetate polymers, polyethyleneterephthalate, acrylonitrile-butadiene-styrene, and admixtures thereof. If the housing unit 3 is to be made of glass, then the glass can be selected from the group consisting of soda-lime-silica glass, borosilicate glass, aluminosilicate glass, vycor, vitreous silica, quartz, fused silica, and admixtures thereof.

The mounting bracket 5 in the embodiment shown in FIG. 1 provides for a suspension hook 31 with which to suspend the waste trap 1 in a suds tub (not shown). The mounting bracket 5 provides access for a wash water discharge outlet of a washing machine and an air discharge outlet of a dryer machine to be stabilized and connected to the waste trap 1. A wash water discharge outlet of the washing machine and an air discharge outlet of the dryer machine can be affixed to the mounting bracket 5 by any method known in the art, for instance, and not limited to a clamp or a clip.

FIG. 2 is also a perspective view of another embodiment of the waste trap 1 comprising a housing unit 3, a detachable mounting bracket 15, and a water dish 11, wherein there is an air gap 13 between the water dish 11 and the detachable mounting bracket 15. Also depicted in FIG. 2 is a lid 23. The lid 23 in FIG. 2 is provided with a detachable mounting bracket 15 with which to attach the wash water discharge outlet of the washing machine and an air discharge outlet of the dryer machine to the waste trap 1. The lid 23 also has at least on screen part 25 having a collar 27 and a ventilation filter 29. The collar 27 of the screen part 25 in this example is hingedly attached to the lid 23. This hinged configuration enables quick and easy cleaning of any waste and/or lint by flipping the collar 27 up to clean both the filter 29 and any waste and/or lint caught along the insides of a suds tub (not shown). The ventilation filter 29 can be made from the following, but is not limited to, the group consisting of a wire mesh filter, a paper fiber filter, a plastic fiber filter, a high efficiency particle air (HEPA) filter, and a charcoal filter.

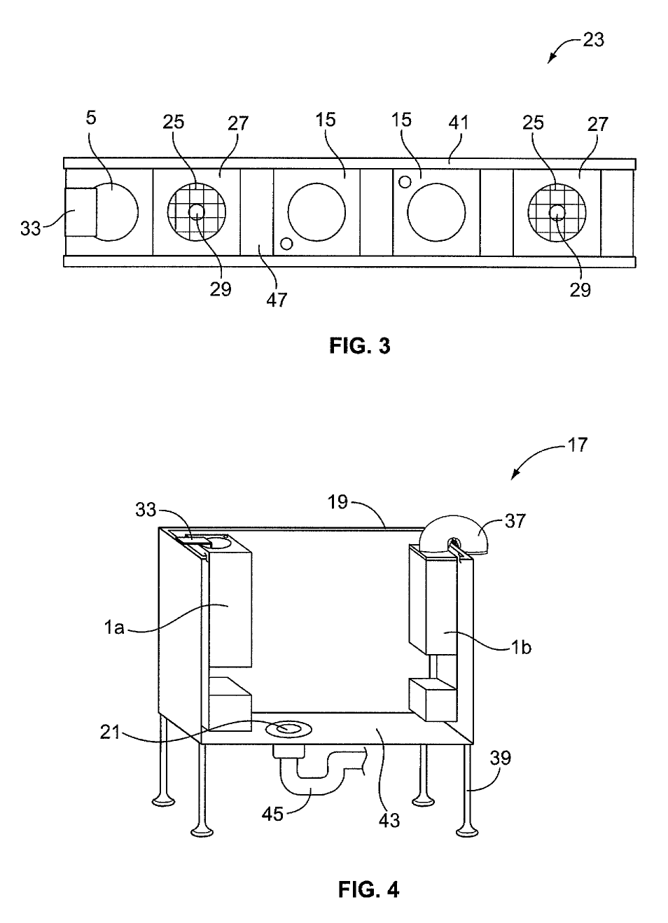

FIG. 3 is a top view of an embodiment of a lid 23 of the present invention. The lid 23 can have a lid collar 41 whereby the lid 23 in this embodiment slidingly receives at least one detachable mounting bracket 15 and/or at least one screen part 25 with a collar 27. It should be noted that a detachable mounting bracket 15 can be slidingly received by the lid collar 41 in any direction so as to better accommodate any angle of receiving a wash water discharge outlet of a washing machine and an air discharge outlet of a dryer machine. By providing a lid 23 having a lid collar 41 which can slidingly receive any number of detachable mounting brackets 15 and/or screens 25 with collars 27, the present invention can be used industrially and also commercially whereby more than one waste trap 1 can be accommodated and thereby waste from more than one washer and/or dryer can be removed from the washer and/or dryer during use. In addition, this configuration provides for optional removal of a screen part 25 for cleaning, disposal, and/or replacement.

Also depicted in FIG. 3 is the top of a mounting bracket 5 having a flange 33 which is retained by the lid 23 whereby the waste trap 1 can be attached to the lid and lowered into a suds tub (not shown) via an orifice 47 in the lid collar 41.

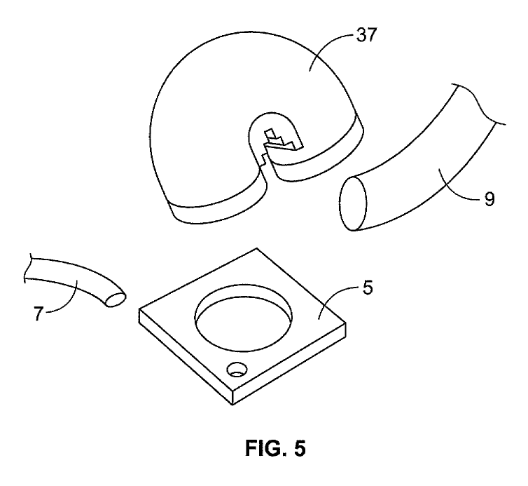

FIG. 4 is a side perspective of an embodiment of a laundry suds tub 17 of the present invention. The suds tub 17 has an upper rim 19 and a lower drain 21. Also shown in this example are two embodiments of waste traps 1a, 1b attached to the suds tub 17. One waste trap 1a can be attached by a clamp 33 which stabilizes the waste trap 1 against the floor 43 of the suds tub 17. A second embodiment of a waste trap 1b in a suds tub 17 is shown in FIG. 4 wherein the waste trap 1b may be suspended above the floor 43 of the suds tub 17 by using a u-tube 37. Other methods of stabilizing and attaching the waste trap 1 are well known in the art. In addition, the distance of the waste trap 1 from the floor 43 of the suds tub 17 can be adjusted as desired and depending on the stability of the configuration.

Also shown in FIG. 4 are optional support legs 39 for the suds tub 17. Depending on the space in which the suds tub 17 is to be placed, the support legs 39 may be useful for accommodating a sewer waste line 45, which is operatively connected to the drain 21. The length and configuration of the support legs 39 can be adjusted and configured according to the desired effect.

The laundry suds tub 17 can be made of material selected from, but not limited to, the group consisting of metal, glass, ceramic, plastic, and admixtures thereof. The dimensions of the laundry suds tub 17 can be made as desired depending on the use of the invention. If the invention is to be used in an industrial capacity, then the suds tub 17 may be very large and enough to accommodate at least one waste trap 1 if not more. In one embodiment, a suds tub 17 can be about 5 inches wide, about 16 inches high and about 24 inches long. In another embodiment, a suds tub 17 can be about 5 inches wide, about 16 inches high and about 32 inches long. The suds tub 17 may be configured to be any size considered useful in the art. For example, the suds tub 17 can be a six-gallon tub 17. For example, the suds tub 17 can be an eight-gallon tub 17.

FIG. 5 provides a perspective view of an optional u-tube 37 of the present invention. The u-tube 37 of the present invention can be adapted to attach to a mounting bracket (5, 15). In FIG. 5 is provided a detachable mounting bracket 15 and a wash water discharge outlet 7 of a washing machine and an air discharge outlet 9 of a dryer machine. A u-tube 37 can be configured to accommodate the water discharge outlet 7 and/or the air discharge outlet 9. Methods of affixing the u-tube to the mounting brackets 5, 15 are well known in the art and may include, but are not limited to, clamps, hooks, welding together. It is also contemplated that the u-tube 37 is configured such that it can be received by either a lid 23 of the present invention or by a suds tub 17 and can provide stability to the waste trap 1 when in a suds tub 17.

One preferred embodiment of the method of using a waste trap 1 includes the steps of obtaining a kit comprising a trap 1 having a housing unit 3, a mounting bracket 5, 15, and a water dish 11, and a laundry suds tub 17; attaching together a wash water discharge outlet 7 of a washing machine to the mounting bracket 5, 15 of the trap 1; connecting together an air discharge outlet 9 of the washing machine to the mounting bracket 5, 15 of the trap 1; plumbing together the drain 21 of the laundry suds tub 17 to a sewer waste line 45; inserting the trap 1 into the laundry suds tub 17; allowing the washing machine to expel waste water through the wash water discharge outlet 7; letting air exhaust from the dryer machine expel through the air discharge outlet 9 of the dryer machine to the trap 1 and into the laundry suds tub 17; collecting lint from the air exhaust from the washer and/or dryer machine.

In the “obtaining” step of a preferred method of the present invention, where the bracket 5 is fixed, there can be a suspension hook 31, a clamp 35, a flange 33, or a u-tube 37 with which to suspend and secure the trap 1 to the inside of the suds tub 17. The invention is not limited to these securement and arrangement devices, and it is contemplated that a person skilled in the art would understand that other means of securement and arrangement of the trap 1 would also be effective. Therefore, an additional optional step of the method may include the step of “securing” the trap 1 to or in the suds tub 17.

In the “obtaining” step of a preferred method of the present invention a mounting bracket 5,15 can be detachable 15. In another preferred embodiment of the method of the invention wherein the mounting bracket 15 is detachable, the user has the flexibility to position the mounting bracket 15 in a direction which can accomodate different angles of the wash water discharge outlet 7 and the air discharge outlet 9. An additional optional step of the method can also, therefore, include the step of “positioning” the mounting bracket 17 on the housing unit 3 of the waste trap 1. No matter the positional arrangement of the mounting bracket 15 in relation to the housing unit 3 of the waste trap 1, the mounting bracket 15 can either be suspended and secured inside the suds tub 17 with a device such as, but not limited to a clamp 35, a flange 33, a u-tube, or a suspension hook 31.

If a lid 23 is included in the kit of the “obtaining” step, the optional “positioning” step may also be performed with a lid 23 wherein a mounting bracket 15 is slidingly received by the lid 23 in a position suitable to accommodate the angle of the outlets 7, 9. The lid 23 can be configured to slidingly receive both a mounting bracket(s) 15 as well as screen part(s) 25 wherein the suds tub 17 has an upper rim 19 adapted to engage a lid 23 which in turn may slidingly receive the screen part(s) 25 and mounting bracket(s) 15, via, for example a collar 41 or a groove. A person of skill in the art would understand that other ways of securing a mounting bracket 15 and/or a screen part 25 to the lid 23 are well known in the art. Such other configuration could include a hinge for each screen part 25 and/or mounting bracket 15, or a hinge for the screen part 25 while the mounting bracket 5 is suspended in the suds tub 17 via, for instance, a suspension hook 31.

Therefore, suspension and securement in the suds tub 17 during the “inserting” step can also be performed including a lid 23 because not only can the lid 23 accommodate the outlets 7, 9, but in addition, the lid 23 has an orifice 47 for placement or insertion of the trap 1 in the suds tub 17. By providing flexible configurations that accommodate at least one waste trap, the present invention can also be used with industrial and commercial size washing and drying events including use with more than one washer and/or dryer. On the other hand, the present invention also contemplates use in smaller spaces, wherein only one washer and/or dryer is used.

The “attaching” and “connecting” steps will differ according to the type of outlets 7, 9, the position of the mounting bracket 5, 15, the configuration of the mounting bracket 5, 15 on the waste trap 1, and the type of mounting bracket 5, 15, among other considerations. Therefore, a person of the art would understand methods known in the art for “attaching” and “connecting” the wash water discharge outlet 7 and the air discharge outlet 9, respectively, to the mounting bracket(s) 5, 15.

The drain 21 of the suds tub 17, in the “plumbing” step is operationally connected to a sewer waste line 45 through which the waste and/or lint is washed out of the water dish 11 and the suds tub 17 for disposal.

The “inserting” step will depend on the type of mounting bracket 5,15 on the waste trap 1. For instance, if a detachable mounting bracket 15 is used then a lid 23 can provide a method of securing the mounting bracket 15 so then the waste trap 1 is inserted through the orifice 47 of the lid 23 into the suds tub 17. For instance, if the mounting bracket 5 is used then, for instance, a suspension hook 31 can be used to insert the waste trap 1 to the suds tub 17. Other configurations and methods of performing the “inserting” step will be known in the art.

The water from the washing event provides a self cleaning mechanism through which any lint and/or waste is disposed of through the drain 21 and into the sewer waste line 45. In a preferred embodiment of the method, there remains water in the water dish 11, placed and replaced there by the “allowing” step of the method. During the “allowing” step the washing machine expels waste water from the wash water discharge outlet into the water dish 11 and into the suds tub 17. This serves at least two purposes including placing and/or replacing water in the water dish 11 and also rinsing any lint and/or waste from a washing and/or drying event that is in the water dish 11 and/or the suds tub 17 for disposal down the drain 21. The constant humidity from water expelled during the “allowing” step performed during washing events aids to provide a constant wet or humid suds tub 17. Thereby, the sides and the floor 43 of the suds tub 17 can also retain any lint and/or waste for eventual disposal down the drain 21. It should be noted that an embodiment of the method of the invention can include an “allowing” step whereby water is placed in the water dish 11 manually as opposed to being placed there by a washing event. In other words, if there is no wash water discharge outlet or a washing event has not been performed, the water can be placed and/or replaced in the water dish 11 through during an “allowing” step which includes manual water placement/replacement in the water dish 11.

In the method of the present invention, it is not necessary that the “allowing” and “letting” steps be performed sequentially or close in time. For instance, to perform a drying event wherein the “letting” step expels air exhaust through the air discharge outlet 9, there need only be water in the water dish 11. The water in the water dish 11 could have been placed there at any time prior to the drying event during the “allowing” step wherein the items being dried are not those that were washed and from which waste water was expelled.

In the preferred method there is a “collecting” step. The “collecting step” can include lint and/or waste from the washer and/or dryer that is trapped in the water dish of the waste trap 1 thereby collecting lint and/or waste. The “collecting step” can also refer to lint and/or waste which is accumulated in the suds tub 17 on the walls or the floor 43 of the suds tub 17. Moreover, the “collecting step” can refer to lint and/or waste being collected in the screen part(s) 25 and particularly in the ventilation filter 29. As described above, the screen part 25 can be cleaned, disposed of, and/or replaced as needed and according to the configuration of the lid 23.

As to the manner of usage and operation of the present invention, the same should be apparent from the above description. Accordingly, no further discussion relating to the manner of usage and operation will be provided.

While a preferred embodiment of the waste trap 1 has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Throughout this specification, unless the context requires otherwise, the word “comprise” or variations such as “comprises” or “comprising” or the term “includes” or variations, thereof, or the term “having” or variations, thereof will be understood to imply the inclusion of a stated element or integer or group of elements or integers but not the exclusion of any other element or integer or group of elements or integers. In this regard, in construing the claim scope, an embodiment where one or more features is added to any of the claims is to be regarded as within the scope of the invention given that the essential features of the invention as claimed are included in such an embodiment.

Those skilled in the art will appreciate that the invention described herein is susceptible to variations and modifications other than those specifically described. It is to be understood that the invention includes all such variations and modification which fall within its spirit and scope. The invention also includes all of the steps, features, compositions and compounds referred to or indicated in this specification, individually or collectively, and any and all combinations of any two or more of said steps or features.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A waste trap for a washing machine and for a dryer machine, the trap comprising:
a housing unit;
a mounting bracket attached to housing unit, wherein the mounting bracket is attachable to a wash water discharge outlet of the washing machine and an air discharge outlet of the dryer machine; and
a water dish attached to the housing unit such that the water dish is configured to receiving waste water from the washing machine and vented air from the dryer machine;
wherein the housing unit provides an air gap between the water dish and the mounting bracket.

2. The trap of claim 1 wherein the mounting bracket is detachable.

3. The trap of claim 1 wherein the mounting bracket comprises a u-tube to accommodate the wash water discharge outlet.

4. The trap of claim 3 wherein the u-tube of the mounting bracket further accommodates the air discharge outlet.

5. The trap of claim 1 further comprising a laundry suds tub attached to the trap, the laundry suds tub having an upper rim and a lower drain.

6. The trap of claim 5 further comprising a lid attached to the laundry suds tub.

7. The trap of claim 6 wherein the lid is configured to receive at least one from the group consisting of a mounting bracket, and a screen part having a collar.

8. The trap of claim 7 wherein the screen part comprises a ventilation filter attached to the collar.

9. The trap of claim 8 wherein the ventilation filter is selected from the group consisting of a wire mesh filter, a paper fiber filter, a plastic fiber filter, a high efficiency particle air (HEPA) filter, and a charcoal filter.

10. The trap of claim 1 further comprising one suspension device selected from the group consisting of a suspension hook, a flange, and a clamp attachable to the mounting bracket.

11. The trap of claim 1 wherein the water dish is rectangular.

12. The trap of claim 5 wherein the laundry suds tub volume is selected from the group consisting of about a six-gallon laundry suds tub, and about an eight-gallon laundry suds tub.

13. The trap of claim 5 wherein the laundry suds tub has support legs.

14. The trap of claim 5 wherein the laundry suds tub has dimensions selected from the group consisting of about 5 inches wide, about 16 inches high and about 24 inches long; and about 5 inches wide, about 16 inches high and about 32 inches long.

15. The trap of claim 5 wherein the water dish sits on the bottom of the laundry suds tub.

16. The trap of claim 1 wherein the housing unit is made of material selected from the group consisting of metal, glass, ceramic, plastic, and admixtures thereof.

17. The trap of claim 16 wherein the metal is selected from the group consisting of stainless steel, vanadium, chromium, iron, nickel, cobalt, copper, zinc, molybdenum, tungsten, aluminum, and admixtures thereof.

18. The trap of claim 16 wherein the plastic is selected from the group consisting of polypropylene, polyethylene, polyvinyl chloride, graphite-impregnated plastic polyester, polyurethanes, polyacryls, polymethacryls, cellulosic polymers, polystyrene, styrene-acryl copolymers, polysiloxanes, urethane-acryl copolymers, siloxane-urethane copolymers, polyurethane-polymethacryl mixtures, vinyl acetate polymers, polyethyleneterephthalate, acrylonitrile-butadiene-styrene, and admixtures thereof.

19. The trap of claim 16 wherein the glass is selected from the group consisting of soda-lime-silica glass, borosilicate glass, aluminosilicate glass, vycor, vitreous silica, quartz, fused silica, and admixtures thereof.

20. The trap of claim 5 where the laundry suds tub is made of material selected from the group consisting of metal, glass, ceramic, plastic, and admixtures thereof.

21. A kit for a waste trap for a washing machine and a dryer machine, the kit comprising:
a trap comprising:
a housing unit;
a mounting bracket attached to the housing unit, the mounting bracket is attachable to a wash water discharge outlet of the washing machine and a discharge outlet of the dryer machine;
a water dish attached to the bottom part of the housing unit such that the water dish is configured to receiving waste water from the washing machine and vented air from the dryer machine, wherein the housing unit provides an air gap between the water dish and the mounting bracket; and
a laundry suds tub having an upper rim and a lower drain.

22. The kit as in claim 21 further comprising a lid attachable to the laundry suds tub
wherein the lid is configured to retain at least one of a mounting bracket, a screen part, a suspension hook, a flange, a clamp, and a u-tube; and wherein the lid has a collar defining an orifice for placement of the trap.

23. The kit as in claim 21 wherein the mounting bracket is detachable.

24. A method of using a waste trap for a washing machine and for a dryer machine, the method comprising the steps of:
obtaining a kit comprising
a trap comprising:
a housing unit;
a mounting bracket attached to the housing unit, the mounting bracket is attachable to a wash water discharge outlet of the washing machine and an air discharge outlet of the dryer machine; and
a water dish attached to housing unit such that the water dish is configured to receiving waste water from the washing machine and vented air from the dryer machine, wherein the housing unit provides an air gap between the water dish and the mounting bracket; and
a laundry suds tub having an upper rim and a lower drain;
attaching together a wash water discharge outlet of the washing machine to the mounting bracket of the trap;
connecting together an air discharge outlet of the dryer machine to the mounting bracket of the trap;
plumbing together the drain of the laundry suds tub to a sewer waste line;
inserting the trap into the laundry suds tub;
allowing the washing machine to expel waste water through the wash water outlet hose into the water dish and into the laundry suds tub;
letting air exhaust from the dryer machine expel through the air discharge outlet of the dryer machine to the trap and into the laundry suds tub; and
collecting lint from the washer and/or dryer machine.

25. The method of claim 24 wherein the kit further comprises a lid attached to the laundry suds tub, wherein the lid is configured to retain at least one of a mounting bracket part, a screen part, a suspension hook, a flange, a clamp, and a u-tube; and wherein the lid has a collar defining an orifice for placement of the trap.

26. The method of claim 24 further comprising the step of positioning the mounting bracket after the obtaining step.

27. The method of claim 25 further comprising the step of positioning the mounting bracket after the obtaining step.

28. The method of claim 24 wherein after the inserting step the waste trap is secured to the suds tub.
